(19) United States
(12) Patent Application Publication
(10) Pub. No.: US 2015/0051747 A1
(43) Pub. Date: Feb. 19, 2015

(54) Method for Multiple Energy Storage Management in Microgrids

(71) Applicant: NEC Laboratories America, Inc., Princeton, NJ (US)

(72) Inventors: Babak Asghari, San Jose, CA (US); Hamed Babazadehrokni, Denver, CO (US); Ratnesh Sharma, Fremont, CA (US)

(73) Assignee: NEC Laboratories America, Inc., Princeton, NJ (US)

(21) Appl. No.: 14/450,594

(22) Filed: Aug. 4, 2014

Related U.S. Application Data
(60) Provisional application No. 61/865,324, filed on Aug. 13, 2013.

(51) Int. Cl. G05F 1/66; G05B 15/02

(52) U.S. Cl. CPC G05F 1/66; G05B 15/02
USPC 700/291

(57) ABSTRACT

The implemented controller uses a cost function to find the optimal rate of charge/discharge for all batteries. In other words, this battery management system aims to find the minimum overall operating cost to run the batteries over a specific period of time.

### RELATED APPLICATION INFORMATION

This application claims priority to provisional application Ser. No. 61/865,324 filed Aug. 13, 2013, entitled “A Method for Multiple Energy Storage Management in Microgrids”, the contents thereof are incorporated herein by reference

### BACKGROUND OF THE INVENTION

The present invention relates generally to energy, and more particularly, to multiple energy storage management in microgrids.

Since the battery management system for big energy storage system need couple of batteries in order to store/release the required energy, management and balancing for all batteries are necessary. In expanding micro-grids, it is more cost effective to add one battery to the energy storage system instead of replacing all batteries. Therefore the employed batteries could be different in terms of initial conditions and other characteristics. It is also not optimal to apply same charge/discharge power on them. Energy storage units are different from conventional generators in a sense that they do not have any fuel costs. The energy storage systems lose their ability (such as power and energy capacity) over time. Main goal of this invention is to optimally decide which battery should charge/discharge and at what rate.

In literature, there is not specific paper about multiple battery controlling. Most proposed methods claim that they consider depth of discharge, rate of discharge and other terms and finally implement the management system Other papers have studied the battery cells and not battery packages. There are some papers which consider the battery packages. For example one paper maximizes the minimum residual energy among all batteries at the end of this period by optimally controlling the discharging and recharging process but not with considering cost.

Accordingly, there is a need for multiple energy storage management in microgrids.

### BRIEF SUMMARY OF THE INVENTION

The invention is directed a computer implemented method for providing real time control of a multi-battery energy storage system that includes calculating overall operating cost data for storage units, and employing the operating cost data for managing the multi battery energy storage units.

In a similar aspect of the invention there is provided a non-transitory storage medium configured with instructions to be implemented by a computer for carrying out the step of providing real time control of a multi-battery energy storage system that includes calculating overall operating cost data for storage units, and employing the operating cost data for managing the multi battery energy storage units.

These and other advantages of the invention will be apparent to those of ordinary skill in the art by reference to the following detailed description and the accompanying drawings.

### BRIEF DESCRIPTION OF THE DRAWINGS

FIG. 1 is a diagram depicting multiple energy storage management in microgrids, in accordance with the invention.

FIG. 2 is a diagram showing key aspects of the inventive multiple energy storage management in microgrids.

FIG. 3 shows an exemplary computer to perform the inventive cyclic decoding of cascaded FEC codes.

### DETAILED DESCRIPTION

The present invention a controller in multi-battery energy storage system to optimally decide which battery should charge/discharge and at what rate. The control unit finds the real time operating cost of each battery and then using the cost function finds the minimum overall operating cost. Key point of our method is find the impact of depth of discharge and rate of discharge at different levels on battery life and consequently finds the life consumption rate which is directly related to the operating cost.

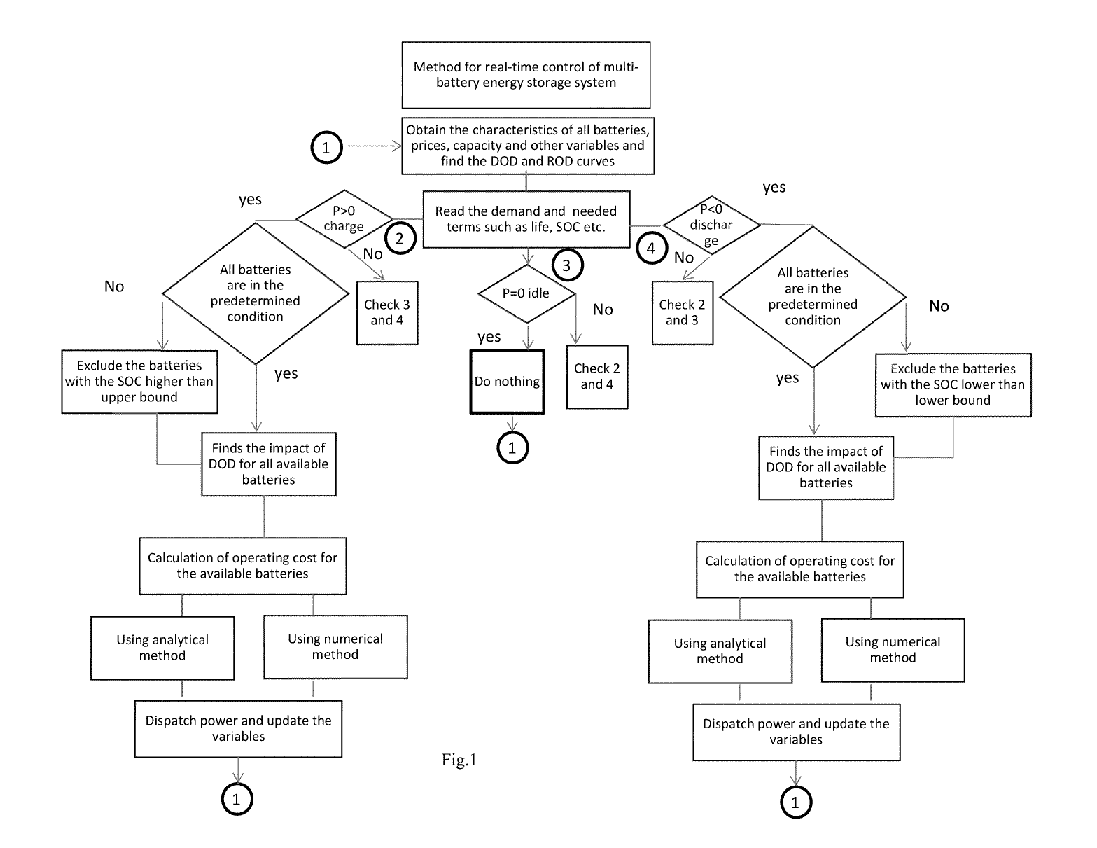

Referring now to FIG. 1, real time control of a multi-battery energy storage system includes obtaining the characteristics of all batteries, prices, capacity and other variables and finding the depth of discharge DOD and rate of discharge ROD curves, block 1. The invention reads the demand and needed terms such as life of battery, state of charge SOC, etc. The charge related checks are made: there is sufficient battery storage charge (p>0) block 2, the battery storage of <0 indicates a discharge, block 4, and charging is idle (p=0), block 3.

If the battery storage is greater than 0, there is a check if all batteries are in the predetermined condition. If not, exclude batteries with a SOC higher than an upper bound. If yes, there is a finding of the impact of depth of discharge DOD for all available batteries. Then there is a calculation of operating cost for the available batteries using either an analytical method of numerical method, a dispatching of power and updating of variables and a process return back to block 1.

If the battery charge state indicates a discharge (p<0), there is a check if all batteries are in the predetermined condition. If not, there is an exclusion of the batteries with the SOC lower than the lower bound. If yes, then there is a finding of the impact of DOD for all available batteries. Then there is a calculation of operating cost for the available batteries using either an analytical method or a numerical method, a dispatching of power and updating of variables and a return back to block 1.

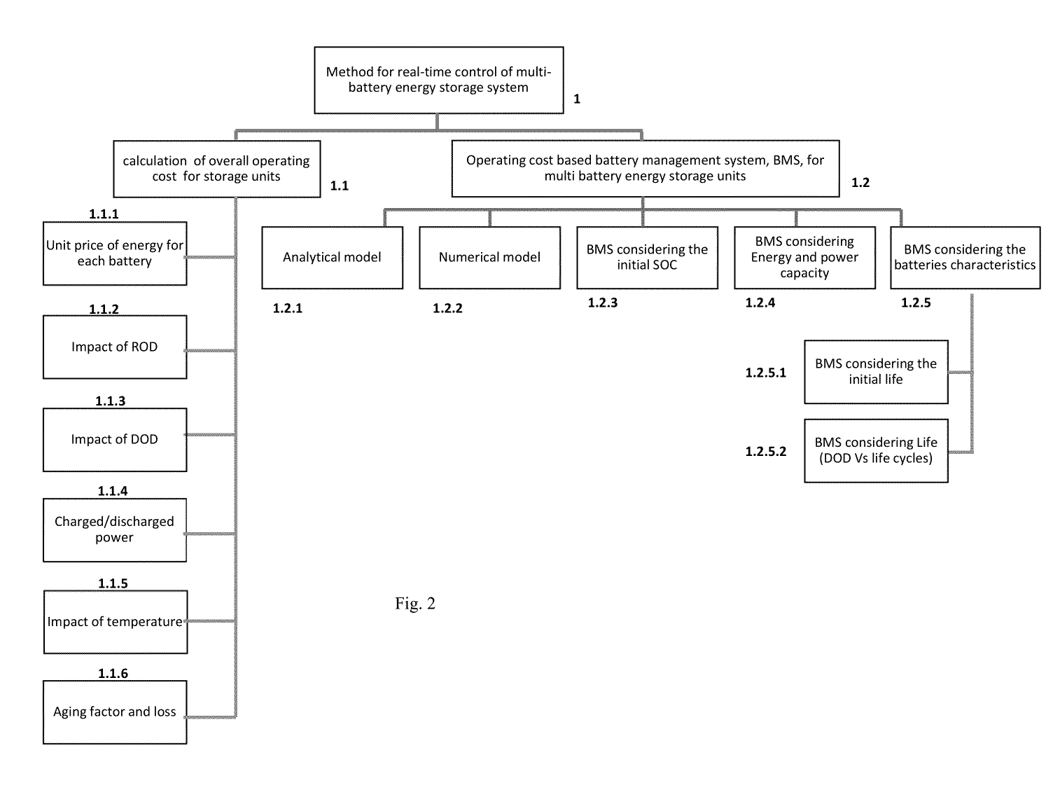

Referring to FIG. 2, key aspects of the invention are diagrammed in block form.

1. Method for real-time control of multi-battery energy storage system: This method manages the storage units in real-time, based on the instantaneous values of operation for each battery depending on the demand.

1.1. Calculation of overall operating cost for storage units: Based on DOD, ROD and unit price of storage system, the operating cost for each battery at different rate of discharge can be calculated.

1.1.1. Unit price of energy for each battery: each battery has a predetermined amount of throughput energy in its life and considering the capital cost of battery, the nit energy price can be calculated.

1.1.2. Impact of ROD: in this model, rate of discharge is modeled as a nonlinear function which due to simplicity the degree is reduced to one. By increasing the rate of charge/discharge, the rate of life consumption increases as well.

1.1.3. Impact of DOD: At each level of DOD, the life consumption rate can be calculated at each sample before finding the optimal values. The impact of DOD on life consumption rate is addressed in the reference section.

1.1.4. charge/discharge power: the cost of operation for each battery is directly proportional to the amount of energy each battery charges/discharges.

1.1.5. Impact of temperature: by keeping the temperature in the acceptable range the battery operates normally and if the temperature passes the upper and lower bound the battery life dramatically decreases which consequently increase the overall operating cost.

1.1.6. Aging factor and loss: batteries lose the energy and power capacity over time, no matter if they are used or not. When the batteries get aged their loss increases which leads to high operating cost.

1.2. Operating cost based battery management system, BMS, for multi battery energy storage units: battery management system finds the optimal dispatch considering the operating cost and control all the batteries by charging/discharging them.

1.2.1. Analytical model: two solutions are proposed. The first one optimizes by using the cost function and finds the minimum operating cost.

1.2.2. Numerical model: this method uses a numerical concept. Calculates the cost of all possible options and then finds the minimum value. This method is very fast and reliable but if the number of employed batteries increases, it loses its advantages.

1.2.2. BMS considering the initial SOC: the BMS considers the initial SOC of batteries in order to find the optimal values.

1.2.2. BMS considering Energy and power capacity: power and energy capacity are two major terms in optimization which have impact on the energy unit's cost and life of battery.

1.2.3. BMS considering the batteries characteristics: the proposed BMS is also able to employ any type of batteries without any condition. The batteries are different in term of energy and power capacity SOC, power cap and also life.

1.2.3.1. BMS considering the initial life: the BMS can also employ the used batteries which is one of the biggest advantages of this battery management system.

1.2.3.2. BMS considering Life (DOD versus life cycles: some batteries can last longer and some have shorter life which in the provided data sheet is the table (or few numbers) of life cycle versus DOD.

The invention may be implemented in hardware, firmware or software, or a combination of the three. Preferably the invention is implemented in a computer program executed on a programmable computer having a processor, a data storage system, volatile and non-volatile memory and/or storage elements, at least one input device and at least one output device. More details are discussed in U.S. Pat. No. 8,380,557, the content of which is incorporated by reference.

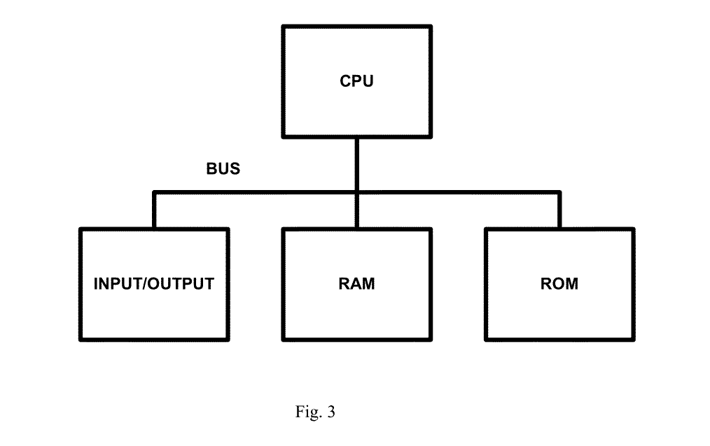

By way of example, a block diagram of a computer to support the system is discussed next in FIG. 3. The computer preferably includes a processor, random access memory (RAM), a program memory (preferably a writable read-only memory (ROM) such as a flash ROM) and an input/output (I/O) controller coupled by a CPU bus. The computer may optionally include a hard drive controller which is coupled to a hard disk and CPU bus. Hard disk may be used for storing application programs, such as the present invention, and data. Alternatively, application programs may be stored in RAM or ROM. I/O controller is coupled by means of an I/O bus to an I/O interface. I/O interface receives and transmits data in analog or digital form over communication links such as a serial link, local area network, wireless link, and parallel link. Optionally, a display, a keyboard and a pointing device (mouse) may also be connected to I/O bus. Alternatively, separate connections (separate buses) may be used for I/O interface, display, keyboard and pointing device. Programmable processing system may be preprogrammed or it may be programmed (and reprogrammed) by downloading a program from another source (e.g., a floppy disk, CD-ROM, or another computer).

Each computer program is tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

From the foregoing, it can be appreciated that the present invention provides a control that uses a cost function to find the optimal rate of charge/discharge for all batteries. In other words, this battery management system aims to find the minimum overall operating cost to run the batteries over a specific period of time.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention.

1. A computer implemented method comprising the steps of:
providing real time control of a multi-battery energy storage system comprising:
calculating overall operating cost data for storage units, and
employing the operating cost data for managing the multi battery energy storage units.

2. The method of claim 1, wherein the overall operating cost is responsive to unit price of energy for each battery, impact of rate of discharge of each battery, impact of depth of discharge of each battery, charged and discharged power of each battery, impact of temperature on each battery, and aging factor and loss of each battery.

3. The method of claim 1, wherein the employing step includes an analytical model or numerical model for calculating operating cost of available batteries.

4. The method of claim 1, wherein the employing step includes considering an initial state of charge of a battery, and energy and power capacity of a battery.

5. The method of claim 1, wherein the employing step includes considering battery characteristics such as initial life and depth of discharge versus life cycles.

6. A transitory storage medium configured with instructions for a computer for carrying out the following steps:
providing real time control of a multi-battery energy storage system comprising:
calculating overall operating cost data for storage units, and
employing the operating cost data for managing the multi battery energy storage units.

7. The storage medium of claim 6, wherein the overall operating cost is responsive to unit price of energy for each battery, impact of rate of discharge of each battery, impact of depth of discharge of each battery, charged and discharged power of each battery, impact of temperature on each battery, and aging factor and loss of each battery.

8. The storage medium of claim 6, wherein the employing step includes an analytical model or numerical model for calculating operating cost of available batteries.

9. The storage medium of claim 6, wherein the employing step includes considering an initial state of charge of a battery, and energy and power capacity of a battery.

10. The storage medium of claim 6, wherein the employing step includes considering battery characteristics such as initial life and depth of discharge versus life cycles.
